(19) United States
(12) Patent Application Publication
(10) Pub. No.: US 2006/0163039 A1
(43) Pub. Date: Jul. 27, 2006

(54) Plastic woven spiral conveyor belt

(75) Inventors: Duane Marshall, Woolford, MD (US); Robert E. Maine JR., Hebron, MD (US)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Cambridge International, Inc.

(21) Appl. No.: 11/250,477

(22) Filed: Oct. 17, 2005

Related U.S. Application Data
(63) Continuation of application No. PCT/US04/11667, filed on Apr. 15, 2004.
(60) Provisional application No. 60/463,340, filed on Apr. 17, 2003.

(51) Int. Cl. B65G 15/54

(52) U.S. Cl. 198/778; 198/848

(57) ABSTRACT

Plastic flat spiral units and plastic connecting rods are conventionally assembled with one another and secured to one another at respective ends, to provide a plastic woven spiral conveyor belt with rounds of turns nested in concave oblique crimp notches on the connecting rods.

This is a continuation of International Application PCT[US2004/011667, with an international filing date of Apr. 15, 2004, which claims priority to U.S. Provisional Application No. 60/463,340, filed Apr. 17, 2003, both now abandoned.

### TECHNICAL FIELD

The present invention is directed to plastic conveyor belts, and more particularly, to plastic flat spiral units and plastic connecting rods assembled with one another and secured to one another at respective ends, to provide a plastic woven spiral conveyor belt with rounds of turns nested in concave oblique crimp notches on the connecting rods.

### BACKGROUND OF THE INVENTION

Woven wire conveyor belts have been around for many years. Early on, it was discovered that the performance of woven wire conveyor belting could be improved by “crimping” the connecting rods, i.e., causing them to be regularly undulatory along their lengths, so that the individual coils of the spiral wires tended to seat, and to remain seated in respective individual crimps or undulations in the crimp rods.

An ingenious way of creating the crimps in the connecting rods, discovered long ago, was to run the rods, during their manufacture, straight through the nip between two meshing gears that were made of harder more durable material than the rods, so that the rods came out looking something like a piece of gum does after it has been squashed between a person's back teeth. In the earliest examples of crimped connecting rod-type woven wire belting, the spiral wires individually have circular transverse cross-sectional figures (profiles) and the crimps in the crimp rods are “straight”, i.e., precisely crosswise (i.e., essentially transversely) of the crimp rods. (In the industry, crimped connecting rods often are called “crimp rods”.) This product is a definite improvement over flat spiral woven round wire conveyor belts with non-crimped rods, because the spiral turns do in fact seat in the crimp pockets on the rods. In fact, this form of construction has become an industry standard. It is believed that in somewhat over half of all woven wire conveyor belting sold these days, the flat spirals are made of round wire, and the connecting rods have straight crimps.

However, since each spiral turn passes around a respective connecting rod at an oblique angle, and the crimp notch is straight, only a limited area point contact is formed between the spiral wire and the crimp rod. This results in a less-than-perfect seating of each spiral turn against the respective crimp rod and leads to significant (and undesirable) longitudinal stretching of the endless conveyor belt, particularly when the belt is used in high temperature and heavy load applications. (When a belt stretches, the excess length must be taken out, or taken up by using adjustable belt tensioning means, so that neither the carrying run nor the return run will sag excessively. Excess belt length, not removed or properly taken up, can cause operating problems, including improper tracking of the belt on and around driving, idling and tensioning rolls.)

A major improvement in the conventional round wire/straight crimp woven wire belting is disclosed in U.S. Pat. No. 2,885,164, issued May 5, 1959, wherein the transverse cross-sections of the flat spiral wires remained circular as before, but the connecting rods were run through slant-toothed gears during their manufacture, so that the crimp notches formed in alternately diametrically opposed sites on the crimp rods were oblique to the longitudinal axis of the crimp rods, with the angle of obliqueness of the crimps equaling the angle of spiraling of the coils of the spiral. The area of interfacial (i.e., superficial) contact between the spiral turns and the crimp rods was thereby substantially increased. As a result, such woven wire belts provide better seating of the spiral wires in the crimp notches, leading to straighter belt tracking and reduced belt stretch despite high temperature use (i.e., for use as product supports in continuous operations through tunnel-type baking and heat-treating ovens), during which the belts may be strongly tensioned in order to minimize product tipping and unwanted contact of the belt with nearby structures.

This type of round wire/diagonal crimp woven wire conveyor belt captured a significant segment of the market because of its superiority in relation to the theretofore conventional round wire/straight crimp woven wire conveyor belt. Nevertheless, it was not considered to be a perfect solution. Two characteristics that this product has are sometimes considered to be unacceptable (or at least undesirable problems). These are, respectively, product stability, and product marking problems. Because conveyor belts made of the flat spirals have many rounded upwardly presented profiles of individual spiral turns in their carrying runs, products, particularly ones that are tall and thin in their as carried orientation, such as empty beverage can bodies, nail polish bottles and the like, are susceptible to tipping over, particularly if there is any jerkiness in the running of the belt.

An example of the types of products that have been adversely affected by the impact of their weight on round wire profiles while being carried on woven wire conveyor belts are: individual blobs of cookie dough, chocolate covered candy bars and similar products, and heat tempered beer bottles and similar products, in which the contact with the belting caused unacceptable (or at least undesirable) markings and distortions on the undersides of the individual product items.

A response to the product indentation problem, was the invention of flat spiral woven wire conveyor belting in which the spiral wires were manufactured using “half round” or “cotter pin” wire of generally D-shaped transverse cross-sectional profile, oriented in the conveyor belt so that the flat side, the facet of the “D” was oriented vertically upwards in the carrying run of the belt.

In the half round wire belts thereafter made, the crimp rods all have had straight crimps, rather than diagonal crimps. Therefore, whereas a flatter surface was provided on the carrying run of the belt, for greater product stability and less product marking, the point contact of the spirals with the crimp notches gave the same disadvantages as earlier belts, i.e., they are oriented excessive stretch in high temperature and heavy load applications.

In a further prior art development, the flat wire concept was successfully teamed up with the diagonal crimp concept, to provide a flat spiral, woven wire conveyor belt in which the crimp notches on the connecting rods, were flat and extended at oblique angles to the longitudinal axes of the connecting rods that precisely matched the angle and profile of the individual spiral turns of the spiral wires. Accordingly, in a balanced woven wire conveyor belt, a longitudinally extending series of transversely extending spirals of wire, usually made of steel and steel alloys, is integrated into a longitudinally extending belt which is usually endless in the longitudinal direction, but has two transversely opposite, i.e., left and right, longitudinally running edges. The transversely extending spirals of wire are joined by a longitudinally extending series of transversely extending rods, or bars also usually made of steel. In the series of spiral wires, alternate ones are spirally wound in a left-handed and right-handed spiraling sense and “skewered” in common on one rod, so that each spiral wire is skewered by two connecting rods, of which one leads and the other trails, assuming that the woven wire conveyor belt thereby constructed has a usual direction of advance in a longitudinal direction. An example of a balanced woven wire conveyor belt is shown in U.S. Pat. No. 5,176,249, assigned to The Cambridge Wire Cloth Company, and incorporated herein by reference.

However, such prior art metal conveyor belt constructions have been difficult to maintain in the required clean and sanitary condition necessary for certain applications. More specifically, the metal components require lubrication, which raises the possibility of lubricant falling into and contaminating food products being conveyed. The metal on metal contact between the belt components which occurs during normal operation can also produce a metal dust debris, and similarly, the lubricant can retain dust and other foreign particles, thus creating unsanitary conditions. These unsanitary conditions are exacerbated by the reluctance to wash the conveyor since washing removes the needed lubricant.

Plastic conveyor belts have been in increasing use, particularly in the food industry where clean and sanitary conditions are a primary consideration. Plastic conveyor belts have also proved useful in applications when dwell time in an oven, a freezer or other food treating environment is needed for a maximum amount of product and with minimum space requirement. These belts are also used in the electronics and computer industries in the conveyance of semi-conductor chips and other electronic components. A plastic conveyor belt is shown in U.S. Pat. No. 5,217,110, the contents of which are incorporated herein by reference. U.S. Pat. No. 5,217,110 discloses a modular plastic conveyor belt of the type having a plurality of modules each with interfitting link ends and a pivot hole in each link end. The link ends are on opposite sides of the modules and pivot rods extend across the belt through the pivot holes to pivotally connect the interfitting link ends of the modules in adjacent rows.

Although plastic modular conveyor belts have overcome the problems of metal debris and lubrication dust associated with conventional woven wire conveyor belts, the modularity of existing plastic conveyor belts and the increased solid surface area of the plastic modules also provide disadvantages such as the inability to adequately clean the pivot point areas, the manufacturing costs associated with injection molding, and the amount of material needed. Accordingly, there is a need for an improved conveyor belt which overcomes the problems of metal debris and lubrication dust associated with conventional woven wire conveyor belts and which also avoids the disadvantages associated with the increased solid surface areas and cleanability issues of known plastic modular conveyor belts.

### SUMMARY OF THE INVENTION

The present invention achieves these objections by providing a plastic woven spiral conveyor belt comprising a longitudinally extending series of transversely extending flat spiral units, each of said spiral units including a plurality of spiral turns defining a leading spiral edge and a trailing spiral edge; a longitudinally extending series of transversely extending connecting rods, each of said connecting rods including a plurality of crimp notches; wherein said plurality of spiral turns of said leading spiral edge of a respective trailing one of said spiral units turn around said plurality of crimp notches in a respective one of said connecting rods and wherein said plurality of spiral turns of said trailing spiral edge of a respective leading one of said spiral units turn around said plurality of crimp notches in said respective one of said connecting rods, thereby interconnecting said series of spiral units; and wherein said spiral units and said connecting rods are made of a plastic material.

The present invention also relates to a conveyor system comprising a plastic woven spiral conveyor belt assembled from interwoven helically-wound plastic spiral units and plastic connector rods, a pair of connector rods being associated with each spiral unit to define open-access recesses of uniform cross-sectional configuration and dimension, said recesses extending in uniformly spaced locations across a width of said belt; and at least one rotatable member including an outer cylindrical surface symmetrically disposed relative to a central axis of rotation of said member and a plurality of uniformly radially-oriented protrusions on said outer cylindrical surface for engaging said open-access recesses of said woven-wire belt, each of said protrusions including a parallelogram-shaped body substantially corresponding to the cross-sectional configuration and dimension of correspondingly-located recesses of said woven-wire belt.

### BRIEF DESCRIPTION OF THE DRAWINGS

These, and other objects, features, and advantages of the present invention will become more readily apparent to those skilled in the art upon reading the following detailed description, in conjunction with the appended drawings in which:

FIG. 1 is a top perspective view of a portion of a plastic woven spiral conveyor belt in accordance with the principles of the present invention.

FIG. 2 is a top plan view thereof.

FIGS. 3 is a right side elevational view thereof, the left side being a mirror image thereof.

FIG. 4 is perspective view of a left-hand spiral before assembly into the conveyor belt shown in FIG. 1.

FIG. 5 is a top view thereof.

FIG. 6 is a right side elevational view thereof, the left side being a mirror image thereof.

FIG. 7 is perspective view of a right-hand spiral before assembly into the conveyor belt shown in FIG. 1.

FIG. 8 is a top view thereof.

FIG. 9 is a perspective view of a connecting rod before assembly into the conveyor belt shown in FIG. 1.

FIG. 10 is top view thereof.

FIG. 11 is perspective view of a sprocket for driving the conveyor belt shown in FIG. 1.

FIG. 12 is schematic side illustration, of a portion of a sprocket as shown in FIG. 11 and a conveyor belt in accordance with FIG. 1 for describing the interfitting relationship of sprocket protrusions within a plastic woven spiral belt according to the invention.

### DETAILED DESCRIPTION OF THE PREFERRED EMBODIMENT

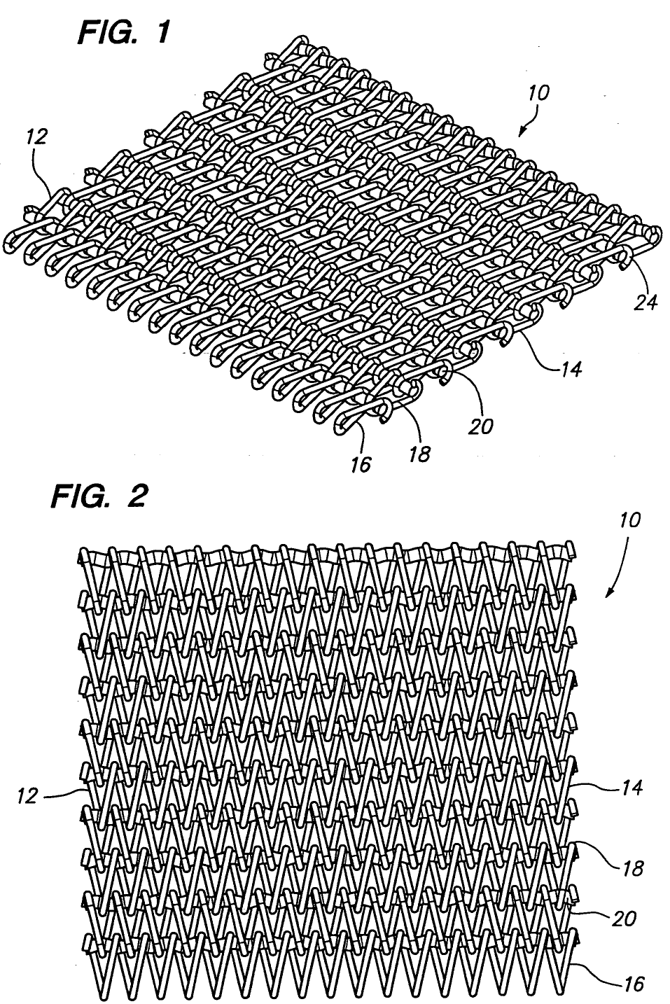

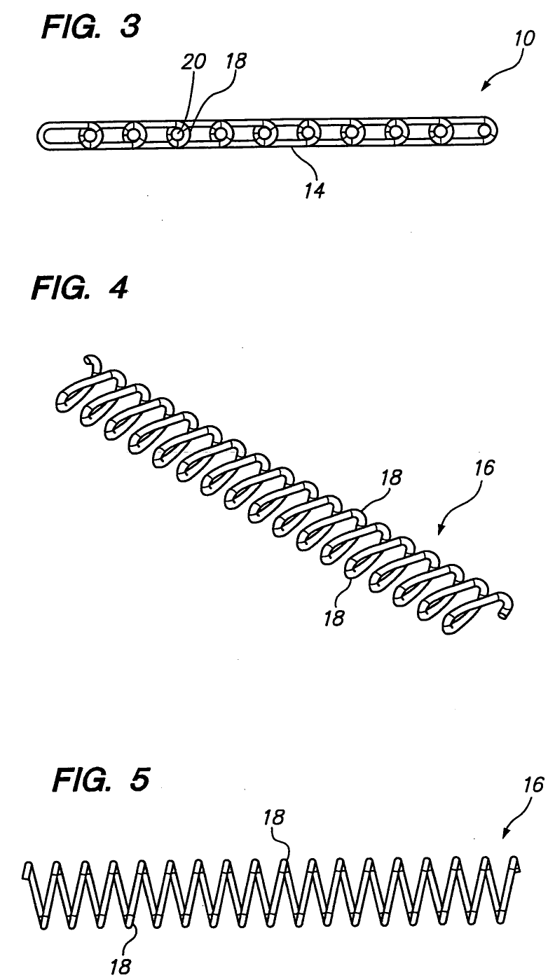

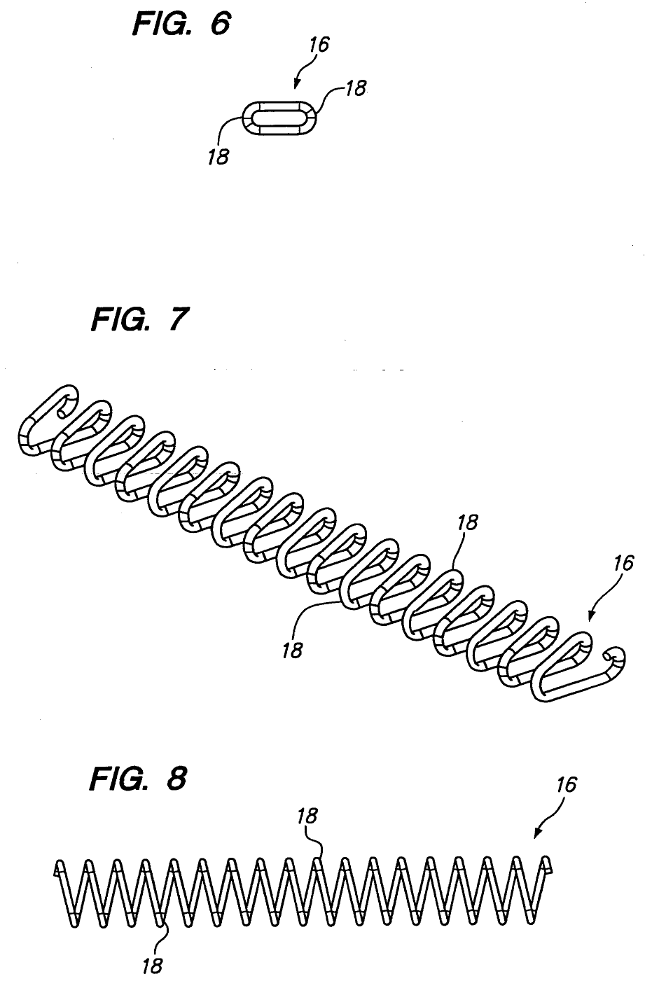

Referring to FIGS. 1-3, a plastic woven spiral conveyor belt is depicted generally by reference numeral 10. The belt 10 has laterally (transversely) opposite, i.e., left and right, longitudinally extending edges 12, 14, and is of indeterminate length in the longitudinal direction (parallel to the edges 12, 14). The belt 10 is composed of a longitudinally extending series of transversely extending flat spiral units 16, alternate ones of which spiral in a left-handed sense and a right-handed sense. FIGS. 4-6 illustrate a left-handed spiral and FIGS. 7-8 illustrate a right-handed spiral in accordance with the present invention. The spiral units are termed “flat spirals”, because, looking at them endwise as shown best in FIGS. 3 and 6, they are not circular ring-shaped, but oval ring-shaped, because they have been “squashed” in a top-to-bottom thickness sense, so that each spiral is wider (in the lengthwise direction of the conveyor belt), than it is tall (in the thicknesswise direction of the conveyor belt).

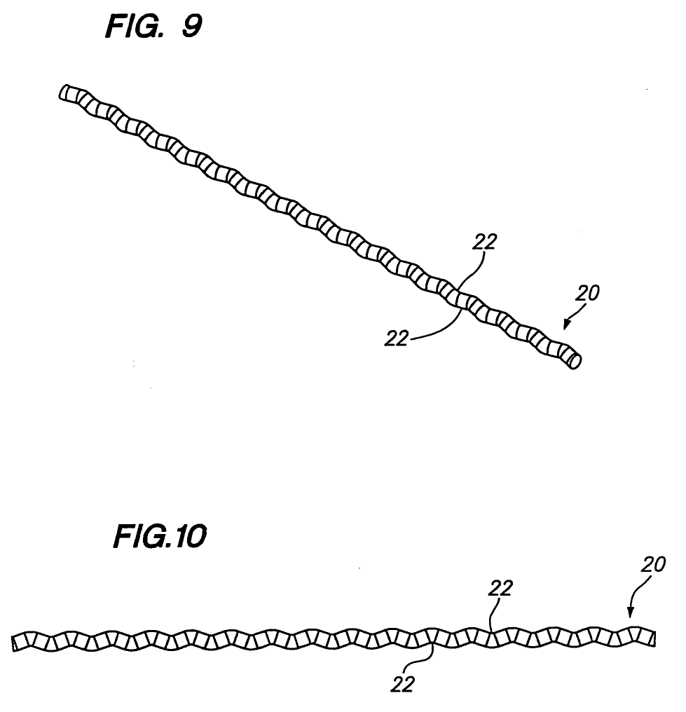

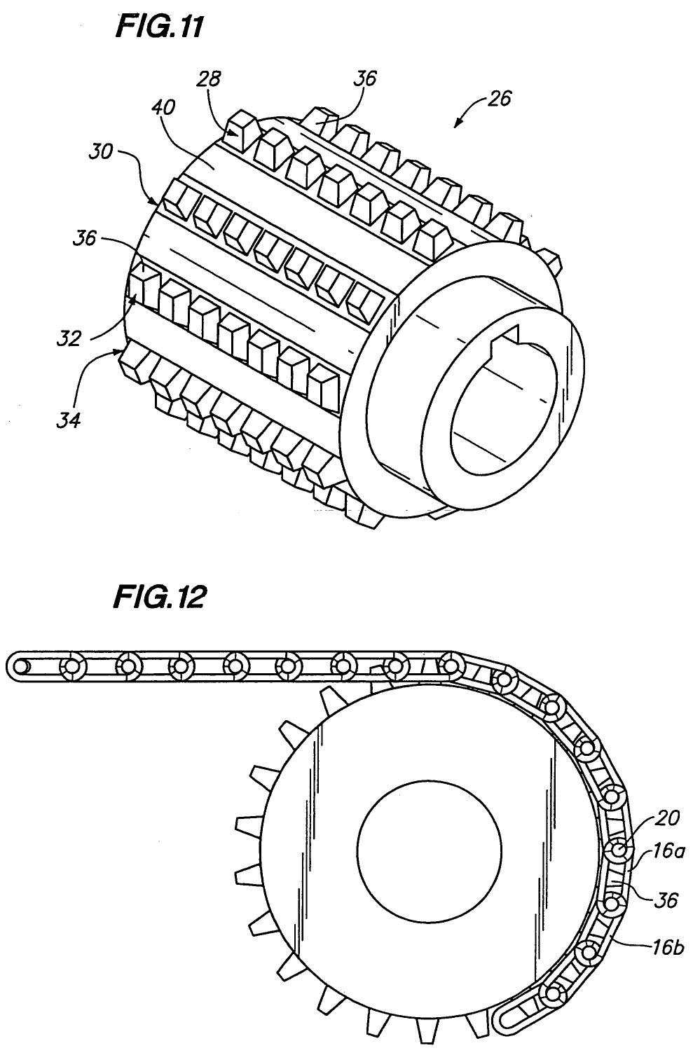

Spiral turns 18 of the units 16 turn around respective connecting rods 20, in respective concave oblique crimp notches 22 formed in the rods 20. Referring to FIGS. 9-10, the notches 22 face upstream and downstream, in the plane of the conveyor belt. The notches extend on axes which are not perpendicular to the plane of the conveyor belt. Rather, on alternate ones of the rods 20, they are tilted to the left, and tilted to the right. On each rod, the notches 22 are provided on two series, one opening towards upstream, and another, diametrically opposed set, opening towards downstream. On each rod, the notches 22 of the two sets are staggered, one on one side being located half-way between two on the other side, but all are tilted in the same direction, i.e., all towards the left on both sides of one rod, and all towards the right on both sides of the next rod.

Accordingly, spiral units 16 of opposite hand need to be wound in opposite directions, whereas crimp rods 20 can be manufactured as one type and simply alternately turned side to side in order to provide the two types needed.

In the embodiment shown, the assembled belting 10 is maintained fastened together by welding ends of spiral units to respective ends of crimp rods as illustrated at 24. Other connecting means such as epoxy, glue, mechanical means and those conventionally used for fastening woven wire conveyor belting together can be used for the same purpose in the product of the present invention.

Typically, both the spiral units 16 and crimp rods 20 are manufactured from indeterminate lengths of plastic stock material, and are not cut to length until after it has been provided with the spiral and undulating shapes disclosed herein. A preferred plastic stock material is polyvinylchloride (PVC) having a density of 0.0513 lb/in³. PVC is also an ideal choice of material for the present invention because of its self-extinguishing characteristic should the conveyor belt catch on fire. Other plastic materials which could also be used include PET, PBT, acetal, Ultem® (polyethermide), and nylon.

In the product 10 of the present invention, the spiral units 16 are flat spirals (i.e., are of oval profile as seen in end view, as shown in FIGS. 3 and 6, with a greater width than thickness), but the preferred transverse cross-sectional shape of the plastic stock material forming unit 16 is a circular cross-sectioned stock. The plastic stock material forming unit 16 and rods 20 preferably has a diameter on the order of about 0.015 to 0.225 in. More preferably, the diameter of the material is 0.035 to 0.177 in. and, most preferably, a material having a diameter of 0.080 to 0.135 in. is used. The weight of a plastic belt is less than that of a comparable metal belt and, according to the present invention, the belt will have a weight of approximately 0.25 lb/ft² to 1.0 lb/ft² depending on the particular plastic stock material that is selected and the particular specifications of the belt. In addition, because the stock material is a plastic, it is possible to add a coloring to the material. Thus, the spiral material and the rod material may have the same color, or different colors, such as red or blue spiral material and white rod material, for example. The use of color, in addition to adding an aesthetic appeal, can also be used to represent a certain belt characteristic such as material from which formed or weight and/or strength. Thus, in a preferred embodiment, a belt of a first color may be made from PVC and a belt of a second color may be made from Ultem®. The use of color in this manner allows belt technicians to easily identify the required belting in a warehouse.

Referring to FIG. 10, parallelogram-shaped protrusions are machined on the roll surface of a sprocket 26 which can interfit with confronting surface openings on the plastic woven spiral conveyor belt 10. The widthwise parallel sides of protrusions are relied on for interfitting with parallel sides of the spiral helical wraps at open-access recesses on the confronting surface of the belt, and repeated in alternate rows of the preferred balanced weave belt 10. The two sides of a bottom access recess, which are essentially parallel to adjacent helical wraps of a spiral, are important to widthwise control. The remaining two lengthwise direction sides can establish points of contact for use of parallelogram-shaped protrusions, depending on crimping of such next adjacent connector rods. In a preferred embodiment, the sprocket is formed from a metal material such as stainless steel 304, for example. There may be certain occasions however when it is desirable to form the sprocket from a plastic material, such as when it is necessary to ground the plastic conveyor belt due to a build up of static electricity. Accordingly, the sprocket may also be formed from a plastic material, such as Delrin® acetal resin.

An initial arrangement for positioning protrusions is shown schematically for sprocket 26. In rows, such as 28, 30, 32, 34, parallelogram-shaped protrusions 36 are machined to provide predetermined positioning of the protrusions on cylindrical surface 40 of sprocket 26. Surface 40 is substantially cylindrical in relation to a central axis of rotation of sprocket 26; and, protrusions are machined to project radially from that surface. Individual circumscribing rows of protrusions are predeterminedly positioned between lateral distal ends of sprocket 26. The number of protrusions selected across sprocket width is selected to provide desired substantially uniform drive across the width of the belt. Additional information concerning drive systems for woven wire conveyor belts, which may be equally applicable to the plastic woven spiral conveyor belt of the present invention, is disclosed in U.S. Pat. Nos. 5,375,695, 5,590,755, 5,816,988, 6,050,394, and 6,041,916, the entire content of each being incorporated herein by reference.

As the flat spiral units 16 are assembled with the crimp rods 20 and secured to produce the conveyor belt 10 shown in FIG. 1, the interfacial surfaces 38 of the turns 18 of the flat spiral units 16 intimately contact the floors of the crimp notches 22 so that there are no gaps. In assembling a woven spiral belt, a single helically wound spiral unit, such as 16, is associated with two connector rods 22 positioned to be sequentially adjacent in the lengthwise direction of belt assembly and intended travel. Such combination of a helically wound spiral and two associated connector rods defines a plurality of widthwise side-by-side open access recesses. Those recesses are used for reception of specially shaped protrusions, such as protrusions 36 on sprocket 26 shown in FIG. 10, which are selectively shaped to provide for uniform drive across belt width and for increasing widthwise dimensional drive contact. Referring to belt 10, and the portion shown in FIG. 12, recesses defined by alternate spirals and associated connector rods are seated on circumferentially spaced protrusions 36, with substantially planar undercut surface preventing interference of helical wraps of spiral 16a, with such seating of protrusions 36 within recesses of spirals 16b. The protrusion pattern, dimensions and spacing are selected to avoid interference with driving of the belt, notwithstanding possible temperature differentials between a sprocket and a belt.

When the belt 10 of the preferred embodiment as illustrated is made of a preferred stock material, PVC, it has an allowable strength of 145 pounds per foot of belt width, an ultimate strength of 1600 pounds per foot of belt width, a weight of 0.510 pounds per square foot, a pitch of 0.5 inches, and a thickness of 0.35 inch. A belt of this composition and mechanical design is suitable for use, wet or dry, in the temperature range of −40° F. to 155° F. The belt 12 may be made of other materials to suit different requirements of use. For instance, it may be made of Ultem® for use in the temperature range of −40° F. to 350° F., of Delrin™ acetyl resin for use in the temperature range of −40° F. to 200° F. (wet) or up to 220° F. (dry). As will be understood by those skilled in the art, these well known plastic materials have different degrees of resistance to various chemicals at various temperatures and concentrations, so it is best to consult a standard chemical resistance guide before selecting the particular plastic to be used for a belt that will be subjected to a possibly harsh chemical during operation of the conveyor.

Test belting made of the conventional woven wire product of U.S. Pat. No. 5,176,249 and of the present invention product of FIGS. 1-10 have been made and tested with favorable results. The conventional product simulated the appearance, structure and material of a product that is presently commercially available. The present invention product, which appeared as indicated in FIGS. 1-10 was made of PVC stock material to have the same overall belt width as the conventional product.

Some physical characteristics of the two test products are provided in the following table. Dimensions are inches, unless otherwise indicated. For comparison purposes only, the term “wire” is used in the table to refer both to the conventional metal wire and the plastic stock material of the present invention.

TABLE 1

| | Conventional Design | Present Invention |
|---|---|---|
| Wire Composition | 304 Stainless Steel | PVC |
| Belt Mesh Count | 36-24-14-14 | 36-24-10-14 |
| Belt Width | 12″ | 12″ |
| Belt Length | 12″ | 12″ |
| Spiral Wire Diameter | 0.080″ | 0.080″ |
| Rod Wire Diameter | 0.080″ | 0.135″ |
| Belt Pitch | 0.5″ | 0.5″ |
| Thickness | 0.275″ | 0.325″ |
| Depth of Crimp | 0.112″ | 0.145″ |
| Load Rating | 724 lb. | 145 lb. |
| Weight/sq. ft. | 2.237 lb. | 0.510 lb. |

Each of the test conveyor belts was driven using 4 inch diameter sprockets, respectively, at the drive and tail ends of the conveyor. A take-up means was provided in the form of a live counterweight take-up providing 156 pounds of counterweight. The belt was driven at 190 linear feet per minute, over a slider bed made of nylon. The total belt length was 14.5 feet, initially, so that, at 190 feet per minute, the belt made approximately 786 complete revolutions per hour. A gauge length of 12 pitches was established and measured on each of the two belt lengths prior to running. The belt tension provided by the counterweight was 120 pounds.

The testing period was 300 hours. During the test, 15 gauge length measurements were taken (most measurements were taken at approximately 2-30 hour intervals). At 100 hours, 200 hours, and 300 hours, sample spirals and crimp rods were removed from each belt for examination. By the end of the test, the belt had made over 235,000 revolutions.

Dimensional analysis showed the spirals of both belts to be virtually unchanged in pitch and thickness after the test. That indicates that all the elongation observed during the test was due to wear.

According to the results of the test, the plastic conveyor belt of the present invention has approximately one-fifth the weight of a comparable size metal conveyor belt and approximately one-fifth the strength or load rating of the metal belt, but achieves approximately the same wear life and elongation. Thus, since less power is required to pull the lighter weight plastic conveyor belt, it is ideally suited for light weight applications where maintaining a clean and sanitary belt surface, as in the food industry, is a primary consideration.

While the present invention has been described with respect to the preferred embodiment, it is to be understood that variations and modifications may be resorted to as will be apparent to those skilled in the art. Such variations and modifications are to be considered within the purview and the scope of the claims appended hereto.

1. A plastic woven spiral conveyor belt comprising:
a longitudinally extending series of transversely extending flat spiral units, each of said spiral units including a plurality of spiral turns defining a leading spiral edge and a trailing spiral edge;
a longitudinally extending series of transversely extending connecting rods, each of said connecting rods including a plurality of crimp notches;
wherein said plurality of spiral turns of said leading spiral edge of a respective trailing one of said spiral units turn around said plurality of crimp notches in a respective one of said connecting rods and wherein said plurality of spiral turns of said trailing spiral edge of a respective leading one of said spiral units turn around said plurality of crimp notches in said respective one of said connecting rods, thereby interconnecting said series of spiral units; and
wherein said spiral units and said connecting rods are made of a plastic material.

2. The plastic woven spiral conveyor belt of claim 1, wherein alternate spiral units in said series of spiral unit spiral in a left-handed sense and a right-handed sense.

3. The plastic woven spiral conveyor belt of claim 1, wherein said plastic material comprises polyvinylchloride.

4. The plastic woven spiral conveyor belt of claim 3, wherein said polyvinylchloride has a density of 0.0513 lb/in.

5. The plastic woven spiral conveyor belt of claim 1, wherein said plastic material is selected from the group consisting of PET, PBT, acetal, polyethermide, and nylon.

6. The plastic woven spiral conveyor belt of claim 1, wherein said flat spiral units and said connecting rods are formed from a plastic stock material having a circular cross section.

7. The plastic woven spiral conveyor belt of claim 6, wherein said plastic stock material has a diameter between approximately 0.015 and 0.225 in.

8. The plastic woven spiral conveyor belt of claim 1, wherein the belt weighs approximately 0.25 lb/ft² to 1.0 lb/ft².

9. The plastic woven spiral conveyor belt of claim 1, wherein said plastic material has a predetermined color.

10. The plastic woven spiral conveyor belt of claim 9, wherein said plastic material forming said spiral units has a first predetermined color and said plastic material forming said connecting rods has a second predetermined color, said first predetermined color being different from said second predetermined color.

11. A conveyor system comprising:
a plastic woven spiral conveyor belt assembled from interwoven helically-wound plastic spiral units and plastic connector rods, a pair of connector rods being associated with each spiral unit to define open-access recesses of uniform cross-sectional configuration and dimension, said recesses extending in uniformly spaced locations across a width of said belt; and
at least one rotatable member including an outer cylindrical surface symmetrically disposed relative to a central axis of rotation of said member and a plurality of uniformly radially-oriented protrusions on said outer cylindrical surface for engaging said open-access recesses of said woven-wire belt, each of said protrusions including a parallelogram-shaped body substantially corresponding to the cross-sectional configuration and dimension of correspondingly-located recesses of said woven-wire belt.

12. The conveyor system of claim 11, wherein a widthwise dimension of each of said protrusions is defined by a first pair of parallel sides of said parallelogram-shaped body extending symmetrically with the central axis of rotation of said outer cylindrical surface, the dimension of said parallel sides being no greater than a width defined by alternating helical wraps of the spiral.

13. The conveyor system of claim 12, wherein a lengthwise dimension of each of said protrusions is defined by a second pair of parallel sides of said parallelogram-shaped body extending symmetrically with a length of said plastic woven belt.

14. The conveyor system of claim 11, wherein said plurality of uniformly radially-oriented protrusions are disposed at a predetermined angle, said angle being defined by alternating helical wraps of the spiral of said plastic woven belt.

15. The conveyor system of claim 11, wherein said parallelogram-shaped body of said protrusions includes a first pair of parallel sides and a second pair of parallel sides, said first pair of parallel sides extending symmetrically relative to the central axis of rotation.

16. The conveyor system of claim 11, wherein said plastic woven belt comprises a balanced plastic woven belt and said protrusions engage said open-access recesses located in preselected rows spaced in the longitudinal direction of assembly of said balanced plastic woven belt.

17. The conveyor system of claim 11, wherein said at least one rotatable member is formed from a plastic material.

18. The conveyor system of claim 11, wherein said at least one rotatable member is formed from a metal material.
